(19) United States
(12) Patent Application Publication
(10) Pub. No.: US 2026/0271071 A1
(43) Pub. Date: Sep. 10, 2026

(54) TRANSMISSION OR RECEPTION SCHEMES USING MEASUREMENT GAP IN WIRELESS COMMUNICATIONS

(71) Applicant: ZTE Corporation, Shenzhen (CN)

(72) Inventors: Jianqiang DAI, Shenzhen (CN); Mengzhu CHEN, Shenzhen (CN); Bo DAI, Shenzhen (CN); Jiajun XU, Shenzhen (CN); Jun XU, Shenzhen (CN)

(21) Appl. No.: 19/658,243

(22) Filed: Apr. 24, 2026

Related U.S. Application Data
(63) Continuation of application No. PCT/CN2023/126630, filed on Oct. 26, 2023.

(51) Int. Cl. H04W 74/0816; H04W 72/231; H04W 74/00

(52) U.S. Cl. CPC H04W 74/0816; H04W 72/231; H04W 74/006

(57) ABSTRACT

Systems, method and apparatus for wireless communication are described. One example method implemented by a user device includes receiving, by the user device, an indication related to measurement gaps in a first period of time and a second period of time; and performing a subsequent operation during a measurement gap according to the indication.

### CROSS-REFERENCE TO RELATED APPLICATIONS

This application is a continuation and claims priority to International Application No. PCT/CN2023/126630, filed on Oct. 26, 2023, the disclosure of which is hereby incorporated by reference herein in its entirety.

### TECHNICAL FIELD

This document relates to systems, devices and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various methods and apparatus for configuring channel state information reference signals for tracking in wireless communications are provided.

In one example aspect, a method of wireless communication is disclosed. The method comprises receiving, by a user device, an indication related to measurement gaps in a first period of time and a second period of time; and performing a subsequent operation during a measurement gap according to the indication.

In another example aspect, a method of wireless communication is disclosed. The method comprises transmitting, by a network device to a user device, an indication related to measurement gaps in a first period of time and a second period of time, wherein the indication allows the user device to perform a measurement or skip the measurement according to the indication.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows an illustration of XR (extended reality) packet arrival and a measurement gap in time domain.

FIG. 2 shows a diagram illustrating a delivery of downlink (DL) video from gNB to a mobile UE.

FIG. 3 illustrates an example of configurations of MGs at a first period of time and a second period of time based on some implementations of the disclosed technology.

FIG. 4 shows an example wireless communications network based on some implementations of the disclosed technology.

FIG. 5 is a block diagram of an example of a wireless communication apparatus based on some implementations of the disclosed technology.

FIGS. 6 and 7 are example flowcharts of a wireless communication method based on some implementations of the disclosed technology.

### DETAILED DESCRIPTION

The disclosed technology provides implementations and examples for transmission and reception schemes during measurement gaps in wireless communications.

Extended reality (XR) such as AR/VR techniques arise in multiple use cases e.g., immersive gaming, smart transport, collaborative and concurrent engineering, etc. From wireless connection perspective, these cases are supposed to be supported based on the enhanced NR wireless network, which requires properties of good capacity with both high data rate and low network latency.

In measurement gap (e.g., 6 ms in every 20 ms), the UE switches radio frequency to receive signal, e.g., SSB of inter frequency for RRM measurement, hence the UE basically does not work on previous serving cell, and UE is not expected to transmit/receive data at the serving cell during the measurement gap. Thus, it is possible to improve capacity for data transmission/reception by enhancing the measurement gap, for example, by utilizing the radio resource of the measurement gap for data transmission/reception at the serving cell.

Table 1 is provided below to show the conventional gap pattern configurations. As shown in Table 1, Gap pattern Id is configured by network. For example, gap pattern Id=4 is configured with 6 ms measurement gap length in every 20 ms measurement gap repetition period. Moreover, gapOffset is also configured, which refers to the starting point of measurement gap.

TABLE 1
Gap Pattern Configurations

| | | Measurement Gap |
|---|---|---|
| | Measurement Gap | Repetition Period |
| Gap Pattern Id | Length (MGL, ms) | (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |

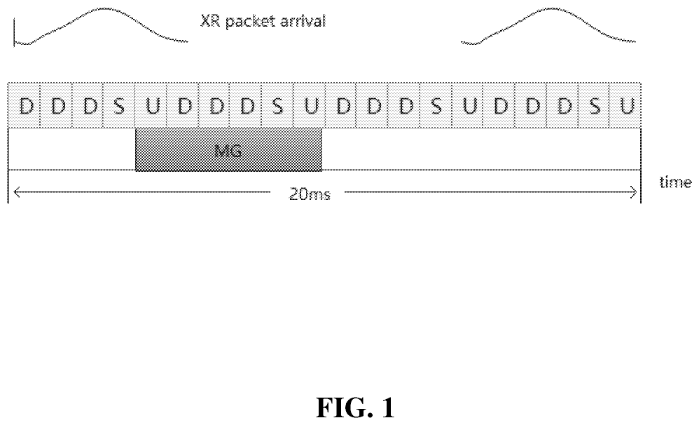

In the conventional art, once configured, the gap pattern can't be adapted for XR traffic. Thus, the configuration mechanism is not flexible enough to satisfy what XR demands. For example, as shown in FIG. 1, XR packet arrival time is random, and may overlap with time duration of measurement gap, which makes the delivery of XR packet get delayed.

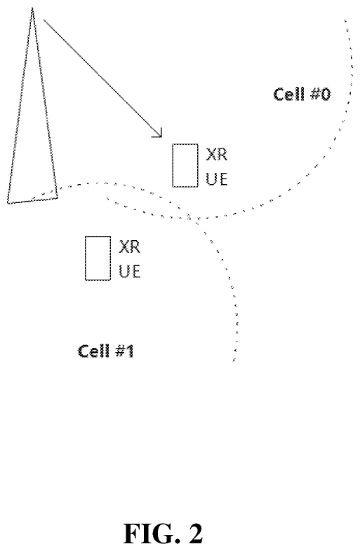

FIG. 2 shows a diagram illustrating a delivery of downlink (DL) video from gNB to mobile UE. With UE's measurements on the serving cell (Cell #0) of active BWP and measurement of neighbouring cell (Cell #1), UE can report the result of the measurement objects to gNB, then gNB can indicate to UE hand over from Cell #0 to Cell #1 if necessary.

Various implementations of the disclosed technology provide transmission or reception schemes using measurement gap in wireless communications. The implementations of the disclosed technology enhance the configuration of Measurement Gap (MG) either via RRC signalling, or dynamic signalling in order to optimize configuration of measurement gap to adapt to specific XR traffic. The implementations may be applied to FR1 and FR2 inter-frequency RRM (radio resource management) measurements with measurement gaps, but other implementations are also possible. According to some implementations of the disclosed technology, it is possible to enhance capacity by utilizing radio resource which has been configured for measurement while various solutions are applied according to different requirements of RRM.

The implementations as discussed below will be applied for UE side and BS side.

### Embodiment A: Enhance Configuration of MG

Case A-1: Enhancement from RRC Signalling Perspective.

In Case A-1, semi-static configuration-based solution is considered. In the example, RRC configuration of measurement gap is utilized to stagger a specific XR traffic, e.g., periodic packet arrival, or packet burst. For example, MG is periodic with a periodicity, for example, 12 ms, and XR traffic is periodic as well with a periodicity, for example, 12 ms. If XR traffic happens at the first 6 ms, e.g., 1^{st} to 6^{th} ms, in each period, the MG is configured at the latter 6 ms, e.g., 7^{th} to 12^{th} ms. By doing so, the XR traffic mostly does not collide with configured MG. In this implementation, a RRC configuration of MG is adopted to stagger the XR traffic in time.

### Implementation a-1: Introducing Parameters of SFN Counter and Reference SFN

With respect to a long period of time, e.g., in T1, in one embodiment, T1 can be 1024 SFNs, and MG can stagger the packet arrival.

The UE measurement gap is set by parameters, Measurement Gap Length, Measurement Gap Repetition Period, in accordance with the received gapOffset. Within each T1 (a time duration, e.g., 1024 SFNs), the first subframe of each gap occurs at an SFN and subframe that meet the following condition:

SFN mod T = FLOOR(gapOffset/10);
subframe = gapOffset mod 10;
with T = MGRP/10;

In the implementations, the following parameters are implemented:

SFN (system frame number) counter: counter that increments with every 1024 SFN.

ReferenceSFN: the reference SFN used in determining the start time of each gap.

The start of the first subframe of MG within each T1 (a time duration, e.g., 1024 SFNs) is same as a time offset relative to the start of the first SFN within each T1. The first subframe of MG refers to the 1st millisecond when MG is configured.

In one embodiment, first period of time (T1) can be a period of XR traffic, or multiple periods of XR traffic, and multiple periods can be an integer.

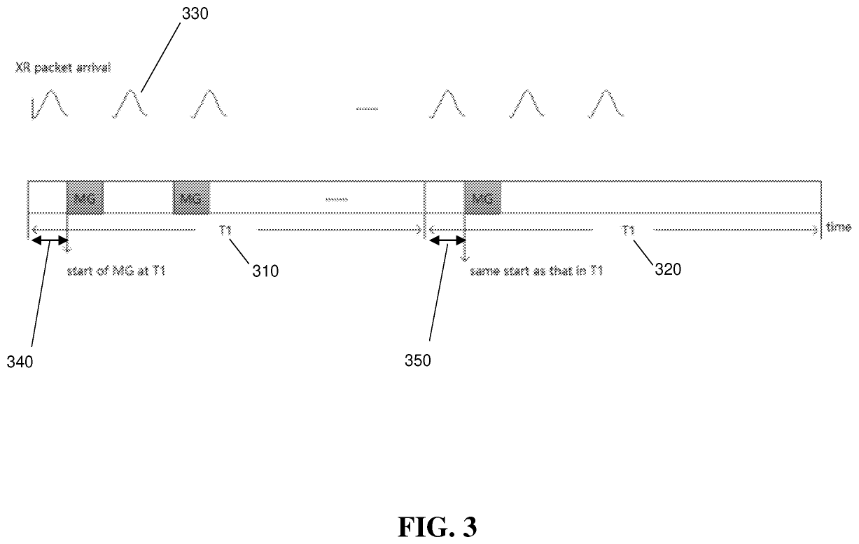

FIG. 3 illustrates starts of MGs at the first T1 and second T1. The MG as illustrated in FIG. 3 can be implemented by the RRC signaling with the formula as described in Implementation a-2 or the RRC signaling with the adjustment of the gapOffset as described in Implementation a-3. In FIG. 3, for the first T1 310 and second T1 320, the duration as indicated with the arrows 340 and 350 is same. In the example, the duration as indicated with the arrows 340 and 350 is same as the time offset. In FIG. 3, the XR packet 330 arrives as shown the curve. The curve in FIG. 3 shows that the XR packet 330 arrives in a period. The additional jitter is added on the top of the ideal arrival time. During T1, multiple packets may arrive periodically.

### Implementation a-2: Formula

In some implementations, in each T1, the start of the first subframe of MG meets the following condition:

if SFN_counter, ReferenceSFN is configured
(SFN_counter* 1024 + SFN) mod T = (ReferenceSFN +
FLOOR (gapOffset/10) ) mod T

### Implementation a-3: Adjusting gapOffset

In some implementations, at the end of each T1, gapOffset is adjusted so that start of the measurement gap at next T1 occurs at the same location as that in the first T1.

### Implementation b: Introducing New Measurement Gap Repetition Period

This implementation provides another solution to optimize configuration of measurement gap. In the implementation, the measurement gap repetition period (MGRP) can be rational value, e.g., 1/fps, e.g., 16.67 ms (fps is frame number per second). In this case, the periodicity of MG is same as periodicity of XR traffic (one/fps). In addition, the gapOffset is configured to stagger the configuration in time.

### Implementation c: Introducing Integer Measurement Gap Repetition Period

This implementation provides another solution to optimize configuration of measurement gap. In the implementation, the MGRP period can be integer. For example, a MGRP that is close to periodicity of XR traffic, e.g., 16 ms, 17 ms, 18 ms, is adopted and then a series of MGRP [17 ms, 17 ms, 16 ms] can align with XR traffic every 1/fps (50 ms).

### Implementation d: Applying a General Formula

This implementation provides another solution to optimize configuration of measurement gap. In the implementation, the first subframe of each measurement gap occurs at a subframe meeting the following condition:

$$Floor ( [ ( SFN\_counter \times 10240 ) + ( SFN \times 10 ) + subframe number ] modulo ( MGRP ) ) = Floor ( ( ReferenceSFN \times 10 + gapOffset ) modulo ( MGRP ) )$$

### Case A-2: Three Types of Measurement Gap Configuration.

The type information of the measurement gap configuration determines which one of the FR1 measurement gap configuration, the FR2 measurement gap configuration, or the UE measurement gap configuration is set up. The type information can be gap_type1, gap_type2, or gap_type 3.

If gap_type1 is set to setup, setup the FR1 measurement gap configuration indicated by the RRC signalling, i.e., the first subframe of each gap occurs at an SFN and subframe meeting the conditions defined at case A-1

If gap_type2 is set to setup, setup the FR2 measurement gap configuration indicated by the RRC signalling, i.e., the first subframe of each gap occurs at an SFN and subframe meeting the conditions defined at case A-1

If gap_type3 is set to setup, setup the UE measurement gap configuration indicated by the RRC signalling, i.e., the first subframe of each gap occurs at an SFN and subframe meeting the conditions defined at case A-1.

### Embodiment B: Enhance MG Via Dynamic Signalling

### Case B-1: L1 Layer Dynamic Signalling

### Implementation a: Introducing New Indication for MG to Indicate a Time Duration During which the MG can be Skipped

In some implementations, the indication (referred to as the MG adaptation field) is introduced to indicate a time duration during which the MG can be skipped. The indication can have N bit(s), N being a natural number. In the implementations, while the RRC configuration of MG is not changed, e.g., the MG is configured as 6 ms in 20 ms according to the legacy, the gNB indicates UE not to perform the measurement during the time duration. Thus, in this implementation, while the indication does not change the configuration of MG, the indication may change the UE behavior within the MG. For example, when the time duration is indicated as first 2 milliseconds, the first 2 milliseconds of the MG is skipped without performing measurements. In the conventional arts, without such indication of skipping, the UE is supposed to conduct measurement during 6 milliseconds when MG is configured as 6 ms.

For example, 1 bit is used for the MG adaption field as follows:
Value ‘0’ indicates no skipping of MG.
Value ‘1’ indicates skipping MG for a time duration provided by the first value in the set of durations that is configured by a higher layer parameter.

In another example, the MG adaption field has 2 bits as follows:
Value ‘00’ indicates no skipping of MG.
Value ‘01’ indicates skipping MG for a duration provided by the first value in the set of durations that is configured by the higher layer parameter.
Value ‘10’ indicates skipping MG for a duration provided by the second value in the set of durations that is configured by the higher layer parameter.
Value ‘11’ indicates skipping MG for a duration provided by the third value in the set of durations, if any; otherwise, if the set of durations includes two values, a use of the ‘11’ value is reserved.

### Implementation b: Introducing New Indication for MG to Indicate to Switch Among MG Configurations

In some implementations, the indication (referred to as the MG adaptation field) is introduced to indicate to switch among MG configurations. The indication can have N bit(s).

For example, 1 bit is used for MG adaption field.
Value ‘0’ indicates that the start of the measurement gap is set according to the first MG configuration, and the measurement gap stops according to other MG configurations, if any. For example, when the dynamic signaling involves multiple MG configurations, if the MG adaptation field has a value “0,” the measurement gap starts according to the first MG configuration among the multiple MG configurations. Then, the measurement gap does not start according to other MG configurations.
Value ‘1’ indicates that the start of the measurement gap is set according to the second MG configuration, and the measurement gap stops according to other MG configurations, if any.

### Implementation c: Introducing New Indication for MG to Indicate to Switch Among MG Configurations and MG Skipping

In some implementations, the indication (referred to as the MG adaptation field) is introduced to indicate to switch among MG configurations and MG skipping. The indication can have N bit(s).

In an example, the MG adaption field has 2 bits as follows:
Value ‘00’ indicates that the start of measurement gap is set according to the first MG configuration and the measurement gap stops according to the second MG configuration, if any.
Value ‘01’ indicates that the start of measurement gap is set according to the second MG configuration and the measurement gap stops according to the first MG configuration, if any,
Value ‘10’ indicates that the measurement gap skips for a duration provided by the value in the set of durations that is configured by the higher layer parameter.

### Implementation d: Introducing New Indication for MG, Each Bit Indicating Whether or not to Skip Measurement for Corresponding One or Multiple Subframes

In some implementations, the indication (referred to as the MG adaptation field) is introduced to indicate whether to skip the measurement gap for one or more subframes. The indication can have N bit(s).

In the example, each bit is used for the MG adaptation field as follows:
Value “1” indicates that the UE is allowed to conduct measurement for corresponding one or multiple subframe.
Value “0” indicates that the UE is NOT allowed to conduct measurement.

For example, when the MG is configured as first 6 ms in the time period of 20 ms, UE knows the time location of MG, e.g., the first six subframes corresponding to first 6 ms. In this implementations, the first bit of 6 bits indicates whether the first subframe is skipped or not, the second bit of 6 bits indicates whether the second subframe is skipped or not, the third bit of 6 bits indicates whether the third subframe is skipped or not, the fourth bit of 6 bits indicates whether the fourth subframe is skipped or not, the fifth bit of 6 bits indicates whether the fifth subframe is skipped or not, and the sixth bit of 6 bits indicates whether the sixth subframe is skipped or not. Thus, each of 6 bits is used to indicate whether a corresponding subframe is skipped or not for measurement.

The above example can be modified to indicate that the value “0” indicates that the UE is allowed to conduct the measurement and that the value “1” indicates that the UE is not allowed to conduct the measurement.

### Implementation e: Introducing New Indication for MG to Indicate that a Time Duration of MG can be Prioritized Over Performing Measurement

In some implementation, the indication (referred to as the MG adaptation field) is introduced to indicate that a time duration of measurement gap can be prioritized to transmit UL or receive DL. If the UE receives the indication, during that time duration, the UE prioritizes the transmitting UL or receiving DL over the conducting of the measurement. If the UE does not receive the indication, the UE perform the measurement at MG. The indication can have N bit(s).

In the example, the configuration of MG is not changed from the legacy but when the data transmission/reception overlaps the MG, the UE prioritizes to conduct the data transmission/reception. Thus, it is possible to improve the capacity.

For example, each bit is used for MG adaption field
Value ‘0’ indicates NOT to prioritize to transmit UL or receive DL over performing measurement.
Value ‘1’ indicates to prioritize to transmit UL or receive DL for a duration provided by the first value in the set of durations that is configured by the higher layer parameter.

In another example, MG adaption field has 2 bits as follows:
Value ‘00’ indicates NOT to prioritize to transmit UL or receive DL.
Value ‘01’ indicates to prioritize to transmit UL or receive DL for a duration provided by the first value in the set of durations.
Value ‘10’ indicates to prioritize to transmit UL or receive DL for a duration provided by the second value in the set of durations.
Value ‘11’ indicates to prioritize to transmit UL or receive DL for a duration provided by the third value in the set of durations, if any; otherwise, if the set of durations includes two values, a use of the ‘11’ value is reserved.

The following implementations can be further considered:

1. The L1 layer dynamic signalling has one 1 bit. For example, value “1” indicates to activate MG and value “0” indicates to skip the MG. In another example, value “0” indicates to activate MG and value “1” indicates skipping the MG.

2. The dynamic signalling has N bits to indicate unused MG. For example, each bit corresponding to 1 slot indicates whether to require UE to use MG for measurement.

3. Based on the TDRA framework, the dynamic signalling indicates a row index, wherein the row includes the start of symbol, and length of duration. In this case, the indication means these symbols can be skipped, and allowed to transfer data.

4. A dynamic signalling indicates a repetition factor, N_rep, which indicates that the symbols in a slot can be skipped, and that subsequent N_rep slots in the MG can follow the configuration in the slot.

5. A dynamic signalling indicates a repetition factor, N_rep, which indicates N_rep consecutive slots. In the N_rep consecutive slots, the UE is not required to perform measurement.

### Case B-2: DCI Types for L1 Layer Dynamic Signalling.

The dynamic signalling can be from a common DCI, or A UE specific DCI (for per UE measurement), with new bit field for the indication, or a UE specific DCI (for per UE measurement), with modified legacy bit field for the indication, or new DCI format, e.g., DCI format 0-y, or DCI format 1-y.

For example, if a common DCI is designed for the indication of skipping MG, the common DCI may contain multiple bit blocks, wherein each bit block indicates whether each serving cell allows the UE to relax RRM measurements or not. For example, each bit block indicates a set of serving cells where allows the UE relax RRM measurement or not.

In another example, if a common DCI is designed for the indication of adapt MG, the indication can allow UEs in a serving cell to conduct measurements during MG.

### Case B-3: L2 Layer Dynamic Signalling.

In some implementations, the indication is introduced to indicate that a time duration of measurement gap can be skipped.

For example, a DL MAC CE is used for MG adaption, e.g., skipping a MG, or skip a half of MG, or a partial MG, which may overlap with UL/DL transmission,

In another embodiment, a MAC CE is applied for prioritizing to transmit UL or receive DL during a duration that is configured by higher layer parameter.

In another embodiment, the functionality in case B-1, can be implement by MAC CE indication.

In some implementations, a MAC CE is introduced for activating and/or deactivating a measurement gap. For example, if the MAC CE indicates to deactivate the MG, or half of the MG, UE is not needed to conduct the measurement during that MG, or half of MG.

In another embodiment, the structure of MAC CE includes a block for indication of adaptation of measurement gap.

In some implementations, a HARQ-ACK can be reported for the MAC CE indication to gNB. For example, the indication is activated 3 ms after the report of HARQ-ACK.

### Embodiment C: L1/L2 Signalling Update RRC Configuration

In some implementations, if multiple MG configurations are configured, a dynamic signalling indicates to switch among multiple MG configurations. In some other implementations, a dynamic signalling can adjust the gap offset. For example, a DCI indicates an offset that is to be added on the top of the gap offset that has been already configured.

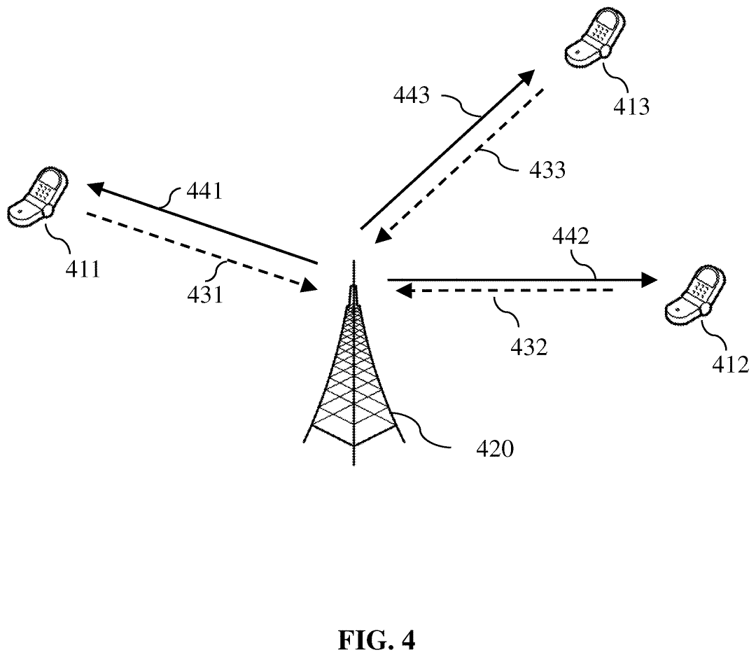

FIG. 4 illustrates an example of a wireless communication system (e.g., a long term evolution (LTE), 5G or NR cellular network) that includes a BS 420 and one or more user equipment (UE) 411, 412 and 413. In some embodiments, the uplink transmissions (431, 432, 433) can include uplink control information (UCI), higher layer signaling (e.g., UE assistance information or UE capability), or uplink information. In some embodiments, the downlink transmissions (441, 442, 443) can include DCI or high layer signaling or downlink information. The UE may be, for example, a smartphone, a tablet, a mobile computer, a machine to machine (M2M) device, a terminal, a mobile device, an Internet of Things (IoT) device, and so on.

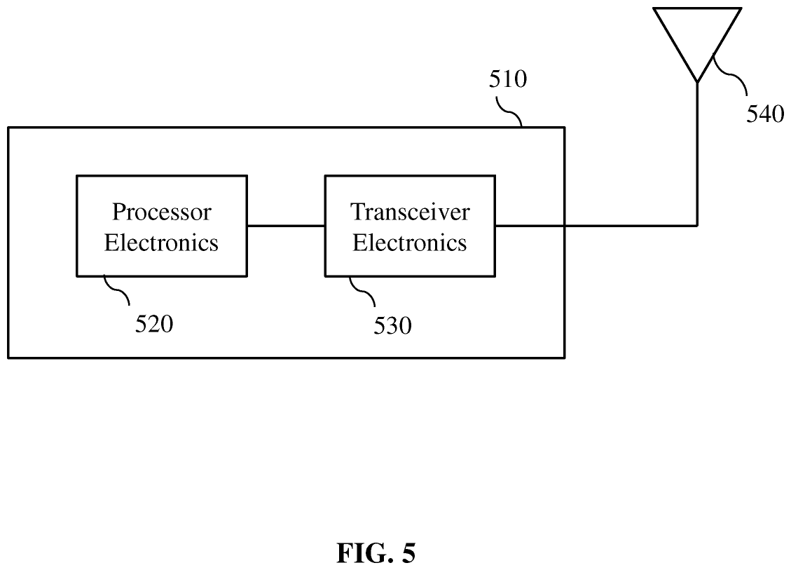

FIG. 5 is a block diagram representation of a portion of an apparatus, in accordance with some embodiments of the presently disclosed technology. An apparatus 510 such as a network device or a base station or a wireless device (or UE), can include processor electronics 820 such as a microprocessor that implements one or more of the techniques presented in this document. The apparatus 510 can include transceiver electronics 530 to send and/or receive wireless signals over one or more communication interfaces such as antenna(s) 540. The apparatus 510 can include other communication interfaces for transmitting and receiving data. Apparatus 510 can include one or more memories (not explicitly shown) configured to store information such as data and/or instructions. In some implementations, the processor electronics 520 can include at least a portion of the transceiver electronics 530. In some embodiments, at least some of the disclosed techniques, modules or functions are implemented using the apparatus 510.

Some preferred embodiments may include the following solutions.

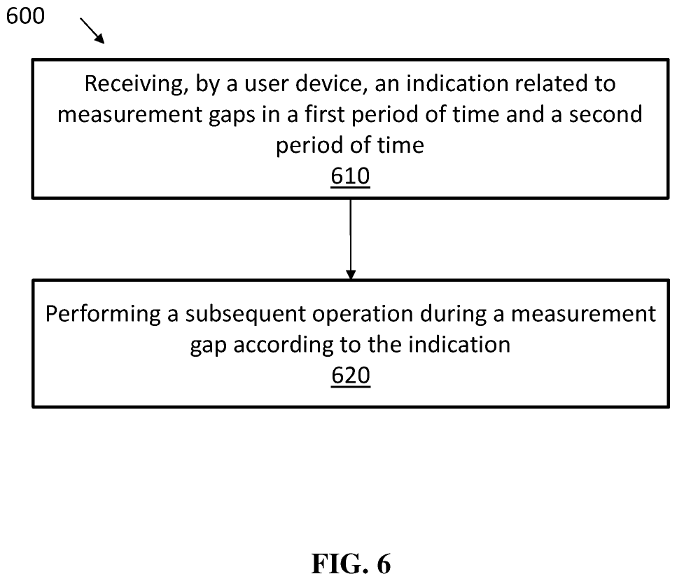

1. A method of wireless communications (e.g., 600 as shown in FIG. 6), comprising: receiving 610, by a user device, an indication related to measurement gaps in a first period of time and a second period of time; and performing 620 a subsequent operation during a measurement gap according to the indication.

2. The method of solution 1, wherein the subsequent operation includes performing a measurement or skipping the measurement.

3. The method of solution 1, further comprising: receiving, by the user device, a first set of data in the first period of time and a second set of data in the second period of time.

4. The method of solution 1, wherein a start of a measurement gap in the first period of time is same as a start of a measurement gap in the second period of time, wherein the start of the measurement gap in the first period of time and the start of the measurement gap in the second period of time are measured from a beginning of the first period of time and a beginning of the second period of time, respectively.

5. The method of solution 1, wherein the indication is included in a RRC signaling that includes a counter parameter and a reference indicator parameter to determine a start time of a measurement gap configuration.

6. The method of solution 1, wherein the indication indicates a gap repetition period that is a rational number or an integer.

7 The method of solution 1, further comprising: adjusting a gap offset based on the indication.

8. The method of solution 1, wherein the indication is a dynamic signaling that includes an indication indicating a time duration during which performing of a measurement by the user device is skipped.

9. The method of solution 1, wherein the indication includes multiple measurement gap configurations, and the indication is a dynamic signaling indicating to switch among the multiple measurement gap configurations.

10. The method of solution 1, wherein the indication is a dynamic signaling that includes an indication having one or multiple bits, each bit indicating whether or not to skip measurement for corresponding one or multiple subframes.

11. The method of solution 1, wherein the indication is a dynamic signaling that includes a time duration of the measurement gap during which a transmission or a reception of data is prioritized over performing a measurement.

12. The method of solution 1, wherein the indication is a dynamic signaling that has one or multiple bits, each bit indicating whether to prioritize a transmission or a reception of data over performing measurement.

13. The method of any of solutions 8 to 12, wherein the dynamic signaling is received in a common DCI or a UE specific DCI.

14. The method of solution 13, wherein the common DCI includes multiple bit blocks, each bit block indicating whether each serving cell allows the user device to conduct relax measurements or not.

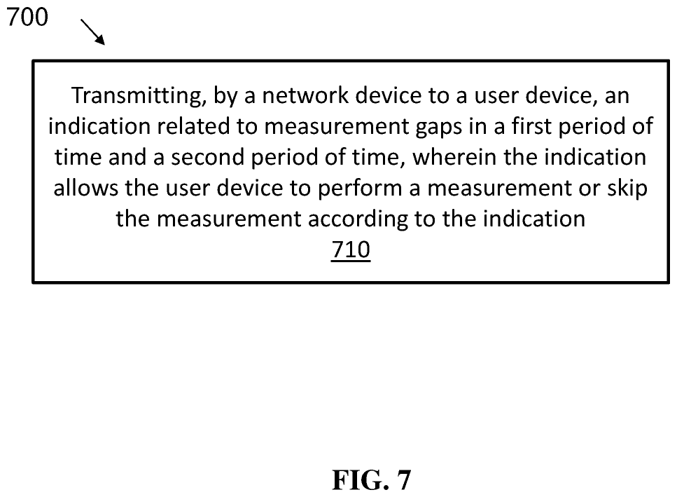

15. A method of wireless communications (e.g., method 700 as shown in FIG. 7), comprising: transmitting 710, by a network device to a user device, an indication related to measurement gaps in a first period of time and a second period of time, wherein the indication allows the user device to perform a measurement or skip the measurement according to the indication.

16. The method of solution 15, wherein a start of a measurement gap in the first period of time is same as a start of a measurement gap in the second period of time, wherein the start of the measurement gap in the first period of time and the start of the measurement gap in the second period of time are measured from a beginning of the first period of time and a beginning of the second period of time, respectively.

17. The method of solution 15, wherein the indication is included in a RRC signaling that includes a counter parameter and a reference indicator parameter to determine a start time of a measurement gap configuration.

18. The method of solution 15, wherein the indication indicates a gap repetition period that is a rational number or an integer.

19. The method of solution 15, wherein the indication allows the user device to adjust a gap offset based on the indication.

20. The method of solution 15, wherein the indication is a dynamic signaling that includes an indication indicating a time duration during which performing of a measurement by the user device is skipped.

21. The method of solution 15, wherein the indication includes multiple measurement gap configurations, and the indication is a dynamic signaling indicating to switch among the multiple measurement gap configurations.

22. The method of solution 15, wherein the indication is a dynamic signaling that includes an indication having one or multiple bits, each bit indicating whether to skip measurement for corresponding one or multiple subframes.

23. The method of solution 15, wherein the indication is a dynamic signaling that includes a time duration of a measurement gap during which a transmission or a reception of data is prioritized over performing a measurement.

24. The method of solution 15, wherein the indication is a dynamic signaling that has one or multiple bits, each bit indicating whether to prioritize a transmission or a reception of data over performing measurement.

25. The method of any of solutions 20 to 24, wherein the dynamic signaling is received in a common DCI or a UE specific DCI.

26. The method of solution 25, wherein the common DCI includes multiple bit blocks, each bit block indicating whether each serving cell allows the user device to conduct relax measurements or not.

27. A wireless communication apparatus comprising a processor configured to implement a method recited in any of above solutions.

28. A computer storage medium having code stored thereupon, the code, upon execution by a processor, causing the processor to implement a method recited in any of above solutions.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
receiving, by a user device, an indication related to a measurement gap the indication having a first value or a second value; and
performing a subsequent operation during the measurement gap according to the indication, and
wherein, in response to the indication being set to the first value, the subsequent operation includes skipping the measurement gap for a time duration provided by a first entry in a set of durations that is configured by a higher layer parameter.

2. The method of claim 1, wherein, in response to the indication being set to the second value, the subsequent operation includes performing a measurement without skipping the measurement gap.

3. The method of claim 1, wherein the indication is a UE specific downlink control information (DCI).

4. The method of claim 1, wherein the indication is one bit.

5. The method of claim 1, wherein the indication is a dynamic signaling that includes an indication having one or multiple bits, each bit indicating whether or not to skip measurement for corresponding one or multiple subframes, and wherein the dynamic signaling is received in a common DCI or a UE specific DCI.

6. The method of claim 1, wherein the indication is a dynamic signaling that has one or multiple bits, each bit indicating whether to prioritize a transmission or a reception of data over performing measurement, and wherein the dynamic signaling is received in a common DCI or a UE specific DCI.

7. A method of wireless communications, comprising:
transmitting, by a network device to a user device, an indication related to a measurement gap, the indication having a first value or a second value,
wherein the indication allows the user device to perform a measurement or skip the measurement according to the indication, and
wherein, in response to the indication being set to the first value, the indication causes the user device to skip the measurement gap for a time duration provided by a first entry in a set of durations that is configured by a higher layer parameter.

8. The method of claim 7, wherein, in response to the indication being set to the second value, the indication causes the user device to perform the measurement without skipping the measurement gap.

9. The method of claim 7, wherein the indication is a UE specific downlink control information (DCI).

10. The method of claim 7, wherein the indication is one bit.

11. The method of claim 7, wherein the indication is a dynamic signaling that includes an indication having one or multiple bits, each bit indicating whether to skip measurement for corresponding one or multiple subframes, and wherein the dynamic signaling is received in a common DCI or a UE specific DCI.

12. The method of claim 7, wherein the indication is a dynamic signaling that has one or multiple bits, each bit indicating whether to prioritize a transmission or a reception of data over performing measurement, and wherein the dynamic signaling is received in a common DCI or a UE specific DCI.

13. A wireless communication apparatus comprising processor electronics and at least one memory coupled to the processor electronics and storing instructions that, when executed by the processor electronics, cause the wireless communication apparatus to:
receive an indication related to a measurement gap the indication having a first value or a second value; and
perform a subsequent operation during the measurement gap according to the indication, and
wherein, in response to the indication being set to the first value, the subsequent operation includes skipping the measurement gap for a time duration provided by a first entry in a set of durations that is configured by a higher layer parameter.

14. The wireless communication apparatus of claim 13, wherein, in response to the indication being set to the second value, the subsequent operation includes performing a measurement without skipping the measurement gap.

15. The wireless communication apparatus of claim 13, wherein the indication is a UE specific downlink control information (DCI).

16. The wireless communication apparatus of claim 13, wherein the indication is one bit.

17. The wireless communication apparatus of claim 13, wherein the indication is a dynamic signaling that includes an indication having one or multiple bits, each bit indicating whether or not to skip measurement for corresponding one or multiple subframes, and wherein the dynamic signaling is received in a common DCI or a UE specific DCI.

18. The wireless communication apparatus of claim 13, wherein the indication is a dynamic signaling that has one or multiple bits, each bit indicating whether to prioritize a transmission or a reception of data over performing measurement, and wherein the dynamic signaling is received in a common DCI or a UE specific DCI.
